(19) United States
(12) Patent Application Publication
(10) Pub. No.: US 2026/0269763 A1
(43) Pub. Date: Sep. 10, 2026

(54) ACTIVE CAPABILITY MANAGEMENT OF MULTIPHASE PERMANENT MAGNET DC MOTOR DRIVES

(71) Applicant: Steering Solutions IP Holding Corporation, Saginaw, MI (US)

(72) Inventors: Prathima Nuli, Troy, MI (US); Prerit Pramod, Bellevue, WA (US); Krishna MPK Namburi, Troy, MI (US)

(21) Appl. No.: 19/069,680

(22) Filed: Mar. 4, 2025

(51) Int. Cl. H02P 29/028; B62D 5/04; H02P 25/22

(52) U.S. Cl. CPC H02P 29/028; H02P 25/22; B62D 5/046; H02P 2207/05

(57) ABSTRACT

A method of controlling a dual winding permanent magnet direct current (DW-PMDC) machine includes: determining, based on an initial torque command, a positive machine current; determining, based on the positive machine current, a positive machine voltage; determining, based on first and second DC supply voltages supplied to first and second power converters, a positive machine lower voltage limit; determining, based on the positive machine voltage and the positive machine lower voltage limit, a negative machine voltage; determining, based on the negative machine voltage, a negative machine current; determining, by applying a mathematical transformation to the positive and negative machine current, first and second final current commands; and commanding each of the first and second power converters to apply a DC output voltage to corresponding winding sets of the DW-PMDC machine to cause output currents to be generated in the winding sets in accordance with the corresponding final current commands.

### BACKGROUND

Permanent magnet direct current (PMDC) machines with multiple winding sets are used to provide redundancy in a variety of applications, such as low-cost electric power steering (EPS) applications. A popular PMDC is a dual winding version, also called a DW-PMDC machine, in which two separate windings may be simultaneously powered.

The two separate windings of a DW-PMDC machine may be each fed from corresponding independent DC power sources, which may have different voltages. Differences in the input voltage between the two sides, particularly at the DC link, are important to consider for proper motor drive operation. Conventional solutions may not account for different voltages of the independent DC power sources, which may result in sub-optimal operation and/or an inability to operate the DW-PMDC machine to produce the most torque possible for a given condition.

### SUMMARY

According to one or more embodiments, a method of controlling a dual winding permanent magnet direct current (DW-PMDC) machine having a first winding set and a second winding set is provided. The method comprises: determining, based on an initial torque command

$$( {T}_{e}^{*} ) ,$$

a positive virtual machine current (Iₚ); determining, based on the positive virtual machine current (Iₚ), a positive virtual machine voltage (Vₚ); determining, based on a first DC supply voltage (V_{dc1}) of a power supply to a first power converter and a second DC supply voltage (V_{dc2}) of a power supply to a second power converter, a positive virtual machine lower voltage limit (Vₚₗ); determining, based on the positive virtual machine voltage (Vₚ) and the positive virtual machine lower voltage limit (Vₚₗ), a negative virtual machine voltage (Vₙ); determining, based on the negative virtual machine voltage (Vₙ), a negative virtual machine current (Iₙ); determining, by applying a mathematical transformation to a set of the positive virtual machine current (Iₚ) and the negative virtual machine current (Iₙ) a first final current command

$$( {I}_{1}^{*} )$$

and a second final current command

$$( {I}_{2}^{*} ) ;$$

commanding, based on the first and a second final current command

$$( {I}_{1}^{*} ) ,$$

the first power converter to apply a first DC output voltage to the first winding set and thereby causing a first output current to be generated in the first winding set in accordance with the first final current command

$$( {I}_{1}^{*} ) ;$$

and commanding, based on the second final current command

$$( {I}_{2}^{*} ) ,$$

the second power converter to apply a second DC output voltage to the second winding set and thereby causing a second output current to be generated in the second winding set in accordance with the second final current command

$$( {I}_{2}^{*} ) .$$

According to one or more embodiments, a method of controlling a dual winding permanent magnet direct current (DW-PMDC) machine having a first winding set and a second winding set is provided. The method comprises: determining, based on a first DC supply voltage (V_{dc1}) of a power supply to a first power converter and a second DC supply voltage (V_{dc2}) of a power supply to a second power converter, a positive virtual machine upper voltage limit (Vₚᵤ); determining, based on the positive virtual machine upper voltage limit (Vₚᵤ), a torque capability (T_{cap+}, T_{cap-}) of the DW-PMDC machine; determining based on an initial torque command

$$( {T}_{e}^{*} )$$

and in accordance with the torque capability (T_{cap+}, T_{cap-}) of the DW-PMDC machine, a limited torque command

$$( {T}_{lim}^{*} ) ;$$

determining, based on the limited torque command

$$( {T}_{lim}^{*} ) ,$$

a positive virtual machine current (Iₚ); determining, based on the positive virtual machine current (Iₚ), a positive virtual machine voltage (Vₚ); determining, based on the positive virtual machine voltage (Vₚ), a negative virtual machine voltage (Vₙ); determining, based on the negative virtual machine voltage (Vₙ), a negative virtual machine current (Iₙ); determining, by applying a mathematical transformation to a set of the positive virtual machine current (Iₚ) and the negative virtual machine current (Iₙ), a first final current command

$$( {I}_{1}^{*} )$$

and a second final current command

$$( {I}_{2}^{*} ) ;$$

commanding, based on the first final current command

$$( {I}_{1}^{*} ) ,$$

the first power converter to apply a first DC output voltage to the first winding set and thereby causing a first output current to be generated in the first winding set in accordance with the first final current command

$$( {I}_{1}^{*} ) ;$$

and commanding, based on the second final current command

$$( {I}_{2}^{*} ) ,$$

the second power converter to apply a second DC output voltage to the second winding set and thereby causing a second output current to be generated in the second winding set in accordance with the second final current command

$$( {I}_{2}^{*} ) .$$

According to one or more embodiments, a system for controlling a dual winding permanent magnet direct current (DW-PMDC) machine having a first winding set and a second winding set is provided. The system comprises: a first power converter configured to selectively conduct current from a first DC voltage source having a first DC supply voltage, and to thereby apply a first DC output voltage to the first winding set of the DW-PMDC machine; a second power converter configured to selectively conduct current from a second DC voltage source having a second DC supply voltage, and to thereby apply a second DC output voltage to the second winding set of the DW-PMDC machine; and a controller. The controller is configured to: determine, based on an initial torque command

$$( {T}_{e}^{*} ) ,$$

a positive virtual machine current (Iₚ); determine a positive virtual machine voltage (Vₚ) based on the positive virtual machine current (Iₚ); determine, based on a first DC supply voltage (V_{dc1}) and a second DC supply voltage (V_{dc2}), a positive virtual machine lower voltage limit (Vₚₗ); determine, based on the positive virtual machine voltage (Vₚ) and the positive virtual machine lower voltage limit (Vₚₗ), a negative virtual machine voltage (Vₙ); determine, based on the negative virtual machine voltage (Vₙ), a negative virtual machine current (Iₙ); determine, by applying a mathematical transformation to a set of the positive virtual machine current (Iₚ) and the negative virtual machine current (Iₙ), a first final current command

$$( {I}_{1}^{*} )$$

and a second final current command

$$( {I}_{2}^{*} ) ;$$

command, based on the first final current command

$$( {I}_{1}^{*} ) ,$$

the first power converter to apply the first DC output voltage to the first winding set and thereby causing a first output current to be generated in the first winding set in accordance with the first final current command

$$( {I}_{1}^{*} ) ;$$

and command, based on the second final current command

$$( {I}_{2}^{*} ) ,$$

the second power converter to apply the second DC output voltage to the second winding set and thereby causing a second output current to be generated in the second winding set in accordance with the second final current command

$$( {I}_{2}^{*} ) .$$

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic diagram of an electric power steering system according to the principles of the present disclosure.

FIG. 2 is a schematic diagram of a DW-PMDC motor drive system according to the principles of the present disclosure.

FIG. 3 is a schematic diagram of a motor control system for a multi-winding permanent magnet direct current (PMDC) machine, according to the principles of the present disclosure.

FIG. 4 is a block diagram showing a DW-PMDC motor control system, according to the principles of the present disclosure.

FIG. 5 shows a flow diagram illustrating a first method for controlling a dual wound permanent magnet DC machine, according to the principles of the present disclosure.

FIGS. 6A-6B show a flow diagram illustrating a second method for controlling a dual wound permanent magnet DC machine, according to the principles of the present disclosure.

### DETAILED DESCRIPTION

Referring now to the figures, where the present disclosure will be described with reference to specific embodiments, without limiting the same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

As used herein the terms module and sub-module refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules described below can be combined and/or further partitioned.

Conventional motor drives for a dual winding permanent magnet direct current (DW-PMDC) machines, also called DW-PMDC motors, divides the total torque command by two (2) and feeds half of the torque command to each of two electronic control units (ECUs) that are arranged to supply regulated current to a corresponding half of the DW-PMDC machine. However, such conventional solutions do not consider the fact that if one of the available dc voltages is higher, higher torque may be available from the half of the DW-PMDC machine connected to that ECU.

The present disclosure considers a difference in available voltage on the two sides and operates the motor drive appropriately, both symmetrically and asymmetrically, depending on the capability of the overall system.

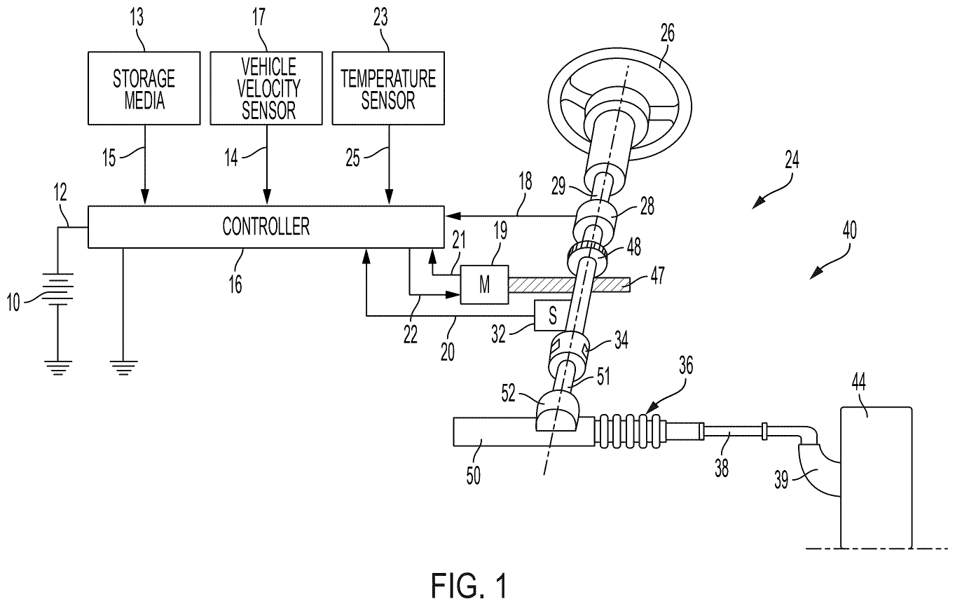

FIG. 1 is a schematic diagram of an electric power steering system (EPS) 40 suitable for implementation of the disclosed techniques. The EPS includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motor drive system generally designated by reference numeral 24 and includes the controller 16 and an electric machine, which could be a permanent magnet direct current (DC) motor, and is hereinafter denoted as motor 19. The controller 16 is powered by the vehicle power supply 10 through supply conductors 12. The controller 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the controller 16 a position signal 20. Motor velocity may be measured with a tachometer, or any other device, and transmitted to controller 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to controller 16 in relation to the amount of twist on the torsion bar. Although this is one type of torque sensor, any other suitable torque-sensing device used with known signal processing techniques will suffice. In response to the various inputs, the controller sends a command 22 to the motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motor drive system 24 as depicted, the controller 16 utilizes the torque, position, and speed, and like, to compute a command(s) to deliver the required output power. Controller 16 is disposed in communication with the various systems and sensors of the motor control system. Controller 16 receives signals from each of the system sensors, quantifies the received information, and provides an output command signal(s) in response thereto, in this instance, for example, to the motor 19. Controller 16 is configured to develop the corresponding voltage(s) out of inverter (not shown), which may optionally be incorporated with controller 16 and will be referred to herein as controller 16, such that, when applied to the motor 19, the desired torque or position is generated. In one or more examples, the controller 16 operates in a feedback control mode, as a current regulator, to generate the command 22. Alternatively, in one or more examples, the controller 16 operates in a feedforward control mode to generate the command 22. Because these voltages are related to the position and speed of the motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the motor 19. Preferably, the temperature sensor 23 is configured to directly measure the temperature of the sensing portion of the motor 19. The temperature sensor 23 transmits a temperature signal 25 to the controller 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the controller 16. The controller 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), controller 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, the controller 16 may include input signal processing and filtering to enable accurate sampling and conversion or acquisitions of such signals from communications interfaces.

As used herein, variables with a tilde (~) above the variable symbol represent an approximation or an estimate, which may be determined by a mathematical calculation, a lookup table, etc. Variables with a bar above the variable symbol represent a vector quantity. Variables with a superscript star (*) represent commands or desired set point values.

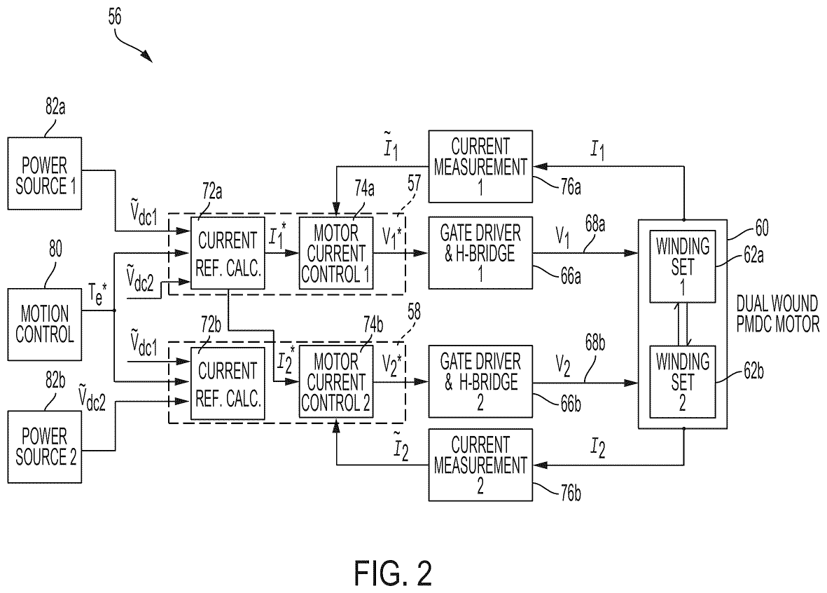

FIG. 2 illustrates a motor drive system 56, which includes a DW-PMDC machine 60 having a first winding set 62a and a second winding set 62b that is electrically isolated from the first winding set 62a. The DW-PMDC machine 60 may be used as the motor 19 in the steering motor drive system 24. However, the DW-PMDC machine 60 of the present disclosure may be used in other applications.

The motor drive system 56 is configured to supply power to the winding sets 62a, 62b for operating the DW-PMDC machine 60 to generate an output torque in accordance with a motor torque command

$${T}_{e}^{*} .$$

The motor drive system 56 includes a first electronic control unit (ECU) 57 and a second ECU 58 that is independent of the first ECU 57. For redundancy, each of the ECUs 57, 58 may control power supply to a corresponding one of the winding sets 62a, 62b. The motor torque command

$${T}_{e}^{*}$$

may be generated by a motion controller 80, such as a controller of an electric power steering (EPS) system, driven by the DW-PMDC machine 60.

The motor drive system 56 includes a first power converter 66a configured to apply a first output voltage V₁ to the first winding set 62a via a first motor lead 68a and based on a first voltage command

$${V}_{1}^{*} .$$

The motor drive system 56 also includes a second power converter 66b that is configured to apply a second output voltage V₂ to the second winding set 62b via a second motor lead 68b and based on a second voltage command

$${V}_{2}^{*} .$$

Each of the power converters 66a, 66b may include a gate driver and H-bridge to generate the output voltages V₁, V₂ as DC voltages that are precisely controlled in magnitude and polarity that may vary with a rotor position of the DW-PMDC machine 60.

The motor drive system 56 also includes two separate and independent DC voltage sources 82a, 82b. The first DC voltage source 82a may supply the first DC supply voltage \tilde{V}_{dc1} for operating the first power converter 66a, and the second DC voltage source 82b may supply the second DC supply voltage \tilde{V}_{dc2} for operating the second power converter 66b. Each of the power converters 66a, 66b may selectively and rapidly switch current from a corresponding one of the DC voltage sources 82a, 82b in order to supply a direct current (DC) output current to a corresponding winding set 62a, 62b of the DW-PMDC machine 60. The first and second DC supply voltages \tilde{V}_{dc1}, \tilde{V}_{dc2} may have similar or identical nominal design voltage values. However, in some situations, the first and second DC supply voltages \tilde{V}_{dc1}, \tilde{V}_{dc2} may be different. For example, if one of the DC voltage sources 82a, 82b is damaged or degraded, the corresponding DC supply voltage \tilde{V}_{dc1}, \tilde{V}_{dc2} may be reduced. The ECUs 57, 58 may each monitor the first DC supply voltage \tilde{V}_{dc1} and the second DC supply voltage \tilde{V}_{dc2}.

The first ECU 57 includes a first current reference calculator 72a that is configured to compute generate a first reference current

$${I}_{1}^{*}$$

for the first winding set 62a and a second reference current

$${I}_{2}^{*}$$

for the second winding set 62b, each based on: the motor torque command

$${T}_{e}^{*} ,$$

the first DC supply voltage \tilde{V}_{dc1}, and the second DC supply voltage \tilde{V}_{dc2}. The fir SCU 57 may transmit the second reference current

$${I}_{2}^{*}$$

to the second ECU 58 via inter-microcontroller (IMC) communications. However, the first ECU 57 may send the second reference current

$${I}_{2}^{*}$$

the second ECU 58 by other means, such as a direct analog I/O signal or on a different communications network. This arrangement, with the first ECU 57 generating both the first reference current

$${I}_{1}^{*} ,$$

and the second reference current

$${I}_{2}^{*} ,$$

may be called a primary dependent architecture.

In some embodiments, the first current reference calculator 72a may be configured to sense the first DC supply voltage \tilde{V}_{dc1} of the first DC voltage source 82a and/or the second DC supply voltage \tilde{V}_{dc2} of the second DC voltage source 82b.

The second ECU 58 includes a second current reference calculator 72b that is configured to generate, at least, the second reference current

$${I}_{2}^{*}$$

for the second winding set 62b based on the motor torque command

$${T}_{e}^{*}$$

and the second DC supply voltage \tilde{V}_{dc2}. The second current reference calculator 72b of the second ECU 58 may be used only in case the first current reference calculator 72a is unavailable. For simplicity of the disclosure, FIG. 2 only shows the reference currents

$${I}_{1}^{*} , {I}_{2}^{*}$$

from the first current reference calculator 72a, which ma b e during normal operation. FIG. 2 does not show the reference currents

$${I}_{1}^{*} , {I}_{2}^{*}$$

from the second current reference calculator 72b, which may be used only in case the first current reference calculator 72a is unavailable.

The second current reference calculator 72b of the second ECU 58 may be similar or identical to the first current reference calculator 72a of the first ECU 57. In some embodiments, the second current reference calculator 72b may also generate the first reference current

$${I}_{1}^{*}$$

for the first winding set 62a. For example, the second current reference calculator 72b may be configured to compute the first reference current

$${I}_{1}^{*}$$

and the second reference current

$${I}_{2}^{*} ,$$

each based on: the motor torque command

$${T}_{e}^{*} ,$$

the first DC supply voltage \tilde{V}_{dc1}, and the second DC supply voltage \tilde{V}_{dc2}. The second ECU 58 may transmit the first reference current

$${I}_{1}^{*}$$

to the first ECU 57 via inter-microcontroller (IMC) communications. However, the second ECU 58 may send the first reference current

$${I}_{1}^{*}$$

to the first ECU 57 by other means, such as a direct analog I/O signal or on a different communications network.

The first ECU 57 also includes a first motor current controller 74a that is configured to command operation of the first power converter 66a. The first motor current controller 74a may compute the first voltage command

$${V}_{1}^{*}$$

based on the first reference current

$${I}_{1}^{*}$$

and based on a first measured current signal Ĩ₁ representing actual current in the first winding set 62a.

The second ECU 58 also includes a second motor current controller 74b that is configured to command operation of the second power converter 66b. The second motor current controller 74b may compute the second voltage command

$${V}_{2}^{*}$$

based on the second reference current

$${I}_{2}^{*}$$

and based on a second measured current signal Ĩ₂ representing actual current in the second winding set 62b.

Each of the first and second voltage commands

$${V}_{1}^{*} , {V}_{2}^{*}$$

are sup ed to the corresponding one of the power converters 66a, 66b, thereby allowing independent voltage control of the two winding sets 62a, 62b. Alternatively, each of the motor current controllers 74a, 74b may send one or more different control signals for controlling operation of the corresponding power converter 66a, 66b, such as duty cycle signals for switches of the corresponding power converter 66a, 66b or a commanded modulation index mi.

The motor drive system 56 includes a first current sensor 76a that is configured to measure current in the first winding set 62a and to supply the first measured current signal Ĩ₁ to the first motor current controller 74a. The motor drive system 56 also includes a second current sensor 76b that is configured to measure current in the second winding set 62b and to supply the second measured current signal Ĩ₂ to the second motor current controller 74b.

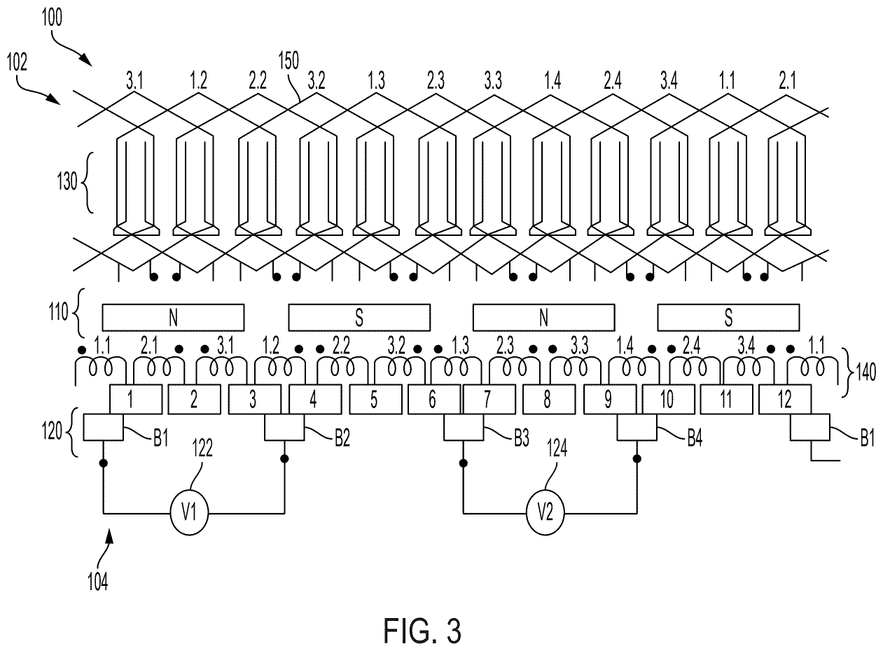

FIG. 3 generally illustrates the motor control system 100 including a multi-winding PMDC machine 102 according to the principles of the present disclosure.

More specifically, the multi-winding PMDC machine 102 includes four stator poles (i.e., two magnet pole pair (N and S) 110, two brush pairs (B1-B4) 120, twelve commutator plates and rotor slots 130 (i.e., gaps between rotor poles), and commutator segments (e.g., 1.1-1.2, 1.3-1.4, 2.1-2.2, 2.3-2.4, 3.1-3.2, and 3.3-3.4) 140 corresponding to each, with a distributed lap winding 150 having a diametrical pitch. It should be noted that the technical solutions described herein are not limited to the motor control system 100 with configuration shown in FIG. 3. Rather, the motor control system 100, in other examples, can include additional brush pairs 120 and/or magnet pole pairs 110. Alternatively, or additionally, the motor control system 100, in other examples, may include a different number of rotor slots 130 or a different manner of winding for the commutator segments 140.

The motor control system 100 shown in FIG. 3 also includes a motor controller 104 configured to supply power for operating the multi-winding PMDC machine 102. The motor controller 104 includes a first voltage source 122 configured to apply a first DC voltage to a first one of the brush pairs 120. The motor controller 104 also includes a second voltage source 124 configured to apply a second DC voltage to a second one of the brush pairs 120. The voltage sources 122, 124 may represent the first power converter 66a and second power converter 66b, respectively.

The general mathematical model of DW-PMDC machine is shown in equation (1), below.

$$[ \begin{matrix}{V}_{1} \\ {V}_{2}\end{matrix} ] = [ \begin{matrix}{L}_{1} s + {R}_{1} & Ms \\ Ms & {L}_{2} s + {R}_{2}\end{matrix} ] [ \begin{matrix}{I}_{1} \\ {I}_{2}\end{matrix} ] + [ \begin{matrix}{K}_{e 1} {ω}_{m} \\ {K}_{e 2} {ω}_{m}\end{matrix} ] + [ \begin{matrix}{V}_{bd 1} \\ {V}_{bd 2}\end{matrix} ] \qquad ( 1 )$$

Torque Tₑ generated by the DW-PMDC machine may be expressed as shown in equation (2), below.

$${T}_{e} = {K}_{e 1} {I}_{1} + {K}_{e 2} {I}_{2} \qquad ( 2 )$$

An alternative model of multiphase PMDC machines obtained after the addition and subtraction of the two sets of phase voltages and currents is shown in equation set (3), below.

$$[ \begin{matrix}{V}_{p} \\ {V}_{n}\end{matrix} ] = [ \begin{matrix}( L + M ) s + R & 0 \\ 0 & ( L - M ) s + R\end{matrix} ] [ \begin{matrix}{I}_{p} \\ {I}_{n}\end{matrix} ] + [ \begin{matrix}2 {K}_{e} {ω}_{m} + {V}_{bdp} \\ {V}_{bdpn}\end{matrix} ] \qquad ( 3 )$$

$${V}_{p} = {V}_{1} + {V}_{2} {V}_{n} = {V}_{1} - {V}_{2}$$

$${I}_{p} = {I}_{1} + {I}_{2} {I}_{n} = {I}_{1} - {I}_{2}$$

$${V}_{bdp} = {V}_{bd 1} + {V}_{bd 2} {V}_{bdn} = {V}_{bd 1} - {V}_{bd 2}$$

$${T}_{e} = {K}_{e} {I}_{p}$$

where Vₚ, Vₙ are voltages of the positive and negative virtual machines, respectively, Iₚ, Iₙ are currents in the positive and negative virtual machines, respectively, V₁, V₂ are the voltages of the winding sets 62a, 62b of the DW-PMDC machine 60, respectively, I₁, I₂ are the currents flowing in the winding sets 62a, 62b of the DW-PMDC machine 60, respectively, Kₑ is the back-emf constant, L₁, L₂ are the self-inductances of the winding sets 62a, 62b of the DW-PMDC machine 60, M is the mutual inductance between the two winding sets 62a, 62b, R₁, R₂ are the resistances of the two winding sets 62a, 62b, V_{bd1}, V_{bd2} are the brush drop voltages of the two halves of the DW-PMDC machine 60, ωₘ is the mechanical speed of the DW-PMDC machine 60 in rad/s, and V_{bdp}, V_{bdn} are the brush drop voltages of the positive and negative virtual machines, respectively.

VIRTUAL MACHINE LIMITS & CAPABILITY: A first step is to determine the limits of virtual machine, which may be essential to determine the peak torque capability for a positive voltage limit and a negative voltage limit. Vₚᵤ and Vₚₗ and are the upper and lower voltage limits of a positive virtual machine, respectively. V_{n_lim} is the voltage limit of the negative virtual machine. The voltage limits Vₚᵤ, Vₚₗ, and V_{n_lim} may each be determined as described below.

Vₚᵤ₊ is a positive upper limit of the positive virtual machine, which determines a positive peak torque capability (T_{cap+}), and Vₚᵤ₋ is a negative upper limit of the positive virtual machine, which determines a negative peak torque capability (T_{cap-}).

Assuming V_{dc1} as an input voltage for a first ECU (ECU1) implementing the first power converter 66a, and V_{dc2} as an input voltage for a second ECU (ECU2) implementing the second power converter 66b, the voltage limits Vₚᵤ, Vₚₗ, and V_{n_lim} may each be determined as described in equation set (4), below.

$${V}_{pu} = {V}_{dc 1} + {V}_{dc 2} \qquad ( 4 )$$

$${V}_{pl} = 2 * min ( {V}_{dc 1} , {V}_{dc 2} )$$

$${V}_{n \_ lim} = {V}_{dc 1} - {V}_{dc 2}$$

Given the limits of the virtual machine, a positive current capability Iₚ+ and a negative current capability Iₚ₋ of the virtual machine may be computed as shown in equations (5)-(6), below.

$${I}_{p +} = \frac{{V}_{pu +} - 2 {K}_{e} {ω}_{m} - {V}_{bdp}}{R} \qquad ( 5 )$$

$${I}_{p -} = \frac{{V}_{pu -} - 2 {K}_{e} {ω}_{m} - {V}_{bdp}}{R} \qquad ( 6 )$$

With the currents, a positive peak torque capability T_{cap+} and a negative peak torque capability T_{cap-} of the virtual machine may be computed as shown in equations (7)-(8), below.

$${T}_{cap +} = {K}_{e} {I}_{p +} \qquad ( 7 )$$

$${T}_{cap -} = {K}_{e} {I}_{p -} \qquad ( 8 )$$

TORQUE COMMAND LIMITING: A limited torque command

$${T}_{lim}^{*}$$

may be obtained by comparing the motor torque command

$${T}_{e}^{*}$$

with the positive peak torque capability T_{cap+} and a negative peak torque capability T_{cap-}, as described in equation (9), below.

$${T}_{lim}^{*} = \{ \begin{matrix}{T}_{cap +} , if {T}_{e}^{*} \geq {T}_{cap +} \\ {T}_{cap -} , else if {T}_{e}^{*} \leq {T}_{cap -} , \\ {T}_{e}^{*}\end{matrix} \qquad ( 9 )$$

POSITIVE AND NEGATIVE VIRTUAL MACHINE CALCULATIONS—A positive virtual machine current Iₚ and a negative virtual machine current Iₙ describe currents in positive and negative virtual machines, respectively. A positive virtual machine voltage Vₚ and a negative virtual machine voltage Vₙ describe voltages of the positive and negative virtual machines, respectively. The positive virtual machine current Iₚ and the positive virtual machine voltage Vₚ may be described by equations (10) and (11), respectively.

$${I}_{p} = \frac{{T}_{lim}^{*}}{{K}_{e}} \qquad ( 10 )$$

$${V}_{p} = \frac{{I}_{p} R + 2 {K}_{e} {ω}_{m} + {V}_{bdp}}{R} \qquad ( 11 )$$

The negative virtual machine current Iₙ may be only calculated when input dc voltage is unequal between ECU1 and ECU2 (i.e. where V_{dc1}≠V_{dc2}). The negative virtual machine voltage Vₙ and the negative virtual machine current Iₙ may be described by equations (12) and (13), respectively.

$${V}_{n} = \{ \begin{matrix}0 , if {V}_{pl -} \leq {V}_{p} \leq {V}_{pl +} \\ ( {V}_{p} - {V}_{pl +} ) * sign ( {V}_{n \_ lim} ) , if {V}_{p} \geq {V}_{pl +} \\ ( {V}_{p} - {V}_{pl -} ) * sign ( {V}_{n \_ lim} ) , if {V}_{p} \leq {V}_{pl -}\end{matrix} \qquad ( 12 )$$

$${I}_{n} = \frac{{V}_{n} - {V}_{bdn}}{R} \qquad ( 13 )$$

INVERSE TRANSFORMATION OF VIRTUAL MACHINE—An inverse transformation may be used to compute final current commands

$${I}_{1}^{*} , {I}_{2}^{*}$$

for each of the of the winding sets 62a, 62b of the of the DW-PMDC machine 60, as shown in equations (14) and (15) below:

$${I}_{1}^{*} = \frac{{I}_{p} + {I}_{n}}{2} \qquad ( 14 )$$

$${I}_{2}^{*} = \frac{{I}_{p} - {I}_{n}}{2} \qquad ( 15 )$$

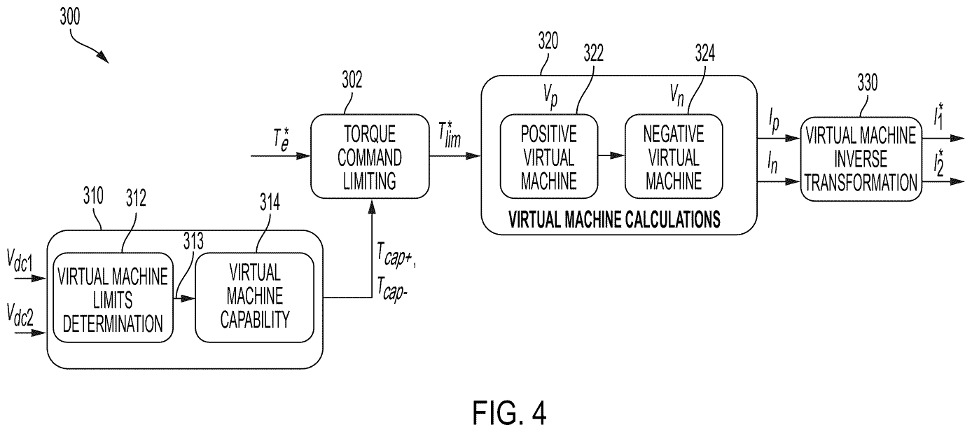

FIG. 4 is a block diagram showing a DW-PMDC motor control system 300, according to the principles of the present disclosure. The DW-PMDC motor control system 300 may represent a control strategy for operating the current reference calculators 72a, 72b. The DW-PMDC motor control system 300 generates current commands

$${I}_{1}^{*} , {I}_{2}^{*} ,$$

for the First motor current controller 74a and the second motor current controller 74b, respectively, to enable the motor current controllers 74a, 74b to utilize the maximum DC voltage available from the corresponding DC voltage sources 82a, 82b 82a, 82b. The determination of current commands is obtained by considering the 2 halves of the DW-PMDC machine 60 as a full virtual machine via a transformation of 2 half machines to a full machine.

The DW-PMDC motor control system 300 includes a torque commend limiter 302 that is configured to determine a limited torque command

$$( {T}_{lim}^{*} )$$

based on an initial torque command

$$( {T}_{e}^{*} )$$

and in accordance with a torque capability (T_{cap+}, T_{cap-}) of the DW-PMDC machine 60. The torque command limiter 302 may calculate the limited torque command

$$( {T}_{lim}^{*} )$$

as described in equation (9), above.

The DW-PMDC motor control system 300 also includes a torque capacity calculator 310 that is configured to determine the torque capability (T_{cap+}, T_{cap-}) of the DW-PMDC machine 60, based on the DC supply voltages (V_{dc1}, V_{dc2}). The torque capability (T_{cap+}, T_{cap-}) includes a positive torque capability (T_{cap+}) of the DW-PMDC machine 60 to generate torque in a first direction, and a negative torque capability (T_{cap-}) of the DW-PMDC machine 60 to generate torque in a second direction opposite the first direction.

The torque capacity calculator 310 includes a virtual machine limits calculator 312 that is configured to determine voltage limit signals 313 representing voltage limits of positive and negative virtual machines, based on the DC supply voltages (V_{dc1}, V_{dc2}). The voltage limits of the positive and negative virtual machines may include one or more of: a positive virtual machine lower voltage limit (Vₚₗ), a positive virtual machine upper voltage limit (Vₚᵤ), and/or a negative virtual machine voltage limit (V_{n_lim}). The virtual machine limits calculator 312 may calculate the voltage limits (Vₚₗ, Vₚᵤ, and V_{n_lim}) of the positive and negative virtual machines as described in equation set (4), above.

The torque capacity calculator 310 also includes a virtual machine torque capability calculator 314 that is configured to determine the torque capability (T_{cap+}, T_{cap-}) of the DW-PMDC machine 60, based on the voltage limits of the positive and negative virtual machines. The torque capacity calculator 310 may compute the torque capability (T_{cap+}, T_{cap-}) of the DW-PMDC machine 60 as described in equations (5)-(8), above.

The DW-PMDC motor control system 300 also includes a virtual machine model 320 that is configured to determine a positive virtual machine current (Iₚ) and a negative virtual machine current (In), each based on the limited torque command

$$( {T}_{lim}^{*} ) .$$

The virtual machine model 320 includes a positive virtual machine model 322, and a negative virtual machine model 324. The positive virtual machine model 322 is configured to determine a positive virtual machine voltage (Vₚ) and the positive virtual machine current (Iₚ). The positive virtual machine model 322 may compute the positive virtual machine voltage (Vₚ) and the positive virtual machine current (Iₚ) as described in equations (10)-(11), above. The negative virtual machine model 324 is configured to determine a negative virtual machine voltage (Vₙ) and the negative virtual machine current (Iₙ). The negative virtual machine model 324 may compute the negative virtual machine voltage (Vₙ) and the negative virtual machine current (Iₙ) as described in equations (12)-(13), above.

The DW-PMDC motor control system 300 also includes a virtual inverse transformation 330 that is configured to a first final current command

$$( {I}_{1}^{*} )$$

and a second final current command

$$( {I}_{2}^{*} )$$

for controlling currents supplied to the windings of the of the DW-PMDC machine 60, and based on the positive virtual machine current (Iₚ) and the negative virtual machine current (Iₙ). The virtual inverse transformation 330 may compute the first final current command

$$( {I}_{1}^{*} )$$

and the second final current command

$$( {I}_{2}^{*} )$$

as described in equations (14)-(15), above.

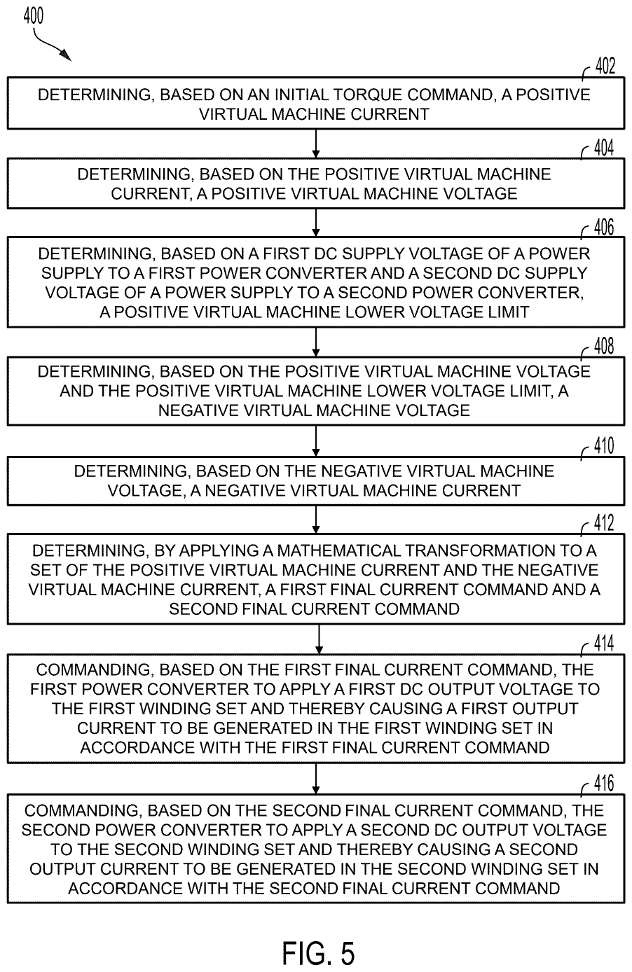

FIG. 5 shows a flow diagram illustrating a first method 400 for controlling a dual winding permanent magnet direct current (DW-PMDC) machine, also called a DW-PMDC machine 60, having a first winding set 62a and a second winding set 62b according to the principles of the present disclosure. The first method 400 can be performed by the controller 16 or either or both of the ECUs 57, 58, in accordance with some embodiments of the present disclosure. As can be appreciated in light of the disclosure, the order of operation within the method is not limited to the sequential execution as illustrated in FIG. 5, but may be performed in one or more varying orders as applicable and in accordance with the present disclosure.

The first method 400 includes determining, at step 402 and based on an initial torque command

$$( {T}_{e}^{*} ) ,$$

a positive virtual machine current (Iₚ). For example, the controller 16 may include hardware and/or software that is configured to implement the positive virtual machine model 322 in order to compute or otherwise determine the positive virtual machine current Iₚ based on the limited torque command

$${T}_{lim}^{*} ,$$

which is based on the initial torque command

$${T}_{e}^{*} .$$

Step 402 may include calculating the positive virtual machine current Iₚ as described in equation (10), above.

In some embodiments, the first method 400 may further include determining, based on the first DC supply voltage and the second DC supply voltage, a positive virtual machine upper voltage limit (Vₚᵤ). For example, the controller 16 may include hardware and/or software that is configured to implement the virtual machine limits calculator 312 in order to compute or otherwise determine the positive virtual machine upper voltage limit Vₚᵤ based on the first DC supply voltage V_{dc1} and the second DC supply voltage V_{dc2}. The virtual machine upper voltage limit Vₚᵤ may be calculated as described in equation set (4), above.

In some embodiments, the first method 400 may further include determining, based on the positive virtual machine upper voltage limit (Vₚᵤ), a torque capability (T_{cap+}, T_{cap-}) of the DW-PMDC machine. For example, the controller 16 may include hardware and/or software that is configured to implement the virtual machine torque capability calculator 314 in order to compute or otherwise determine the torque capability (T_{cap+}, T_{cap-}) of the DW-PMDC machine 60 based on the first DC supply voltage V_{dc1} and the second DC supply voltage V_{dc2}. The torque capability (T_{cap+}, T_{cap-}) of the DW-PMDC machine 60 may be calculated as described in equations (5)-(8), above.

In some embodiments, the first method 400 may further include determining, based on the initial torque command

$$( {T}_{e}^{*} )$$

an in accordance with the torque capability (T_{cap+}, T_{cap-}) of the DW-PMDC machine, a limited torque command

$$( {T}_{lim}^{*} ) .$$

For example, the controller 16 may include hardware and/or software that is configured to implement the torque command limiter 302 to determine the limited torque command

$$( {T}_{lim}^{*} )$$

based on an initial torque command

$$( {T}_{e}^{*} )$$

and in accordance with a torque capability (T_{cap+}, T_{cap-}) of the DW-PMDC machine 60. The torque command limiter 302 may calculate the limited torque command

$$( {T}_{lim}^{*} )$$

as described in equation (9), above.

In some embodiments, step 402 may include determining the positive virtual machine current (Iₚ) further based on the limited torque command

$$( {T}_{lim}^{*} ) .$$

In some embodiments, determining the positive virtual machine current (Iₚ) further based on the limited torque command (Tₗᵢₘ*) may further includes computing the positive virtual machine current (Iₚ) in accordance with:

$${I}_{p} = \frac{{T}_{lim}^{*}}{{K}_{e}} ,$$

where Kₑ is a back-emf constant of the DW-PMDC machine.

In some embodiments, the torque capability (T_{cap+}, T_{cap-}) of the DW-PMDC machine may include: a positive torque capability (T_{cap+}) of the DW-PMDC machine to generate torque in a first direction, and a negative torque capability (T_{cap-}) of the DW-PMDC machine to generate torque in a second direction opposite the first direction.

In some embodiments, the first method 400 may further include determining, based on the positive virtual machine upper voltage limit (Vₚᵤ), a positive virtual machine positive upper voltage limit (Vₚᵤ₊) for operating the DW-PMDC machine to generate a torque in the first direction. For example, the controller 16 may include hardware and/or software that is configured to implement the virtual machine limits calculator 312 in order to compute or otherwise determine the positive virtual machine positive upper voltage limit Vₚᵤ₊ based on the positive virtual machine upper voltage limit Vₚᵤ. The positive virtual machine positive upper voltage limit Vₚᵤ₊ may be equal to the positive virtual machine upper voltage limit Vₚᵤ.

In some embodiments, the first method 400 may further include determining, based on the positive virtual machine positive upper voltage limit (Vₚᵤ₊), a positive virtual machine positive current limit (I_{P+}) for operating the DW-PMDC machine to generate torque in the first direction. For example, the controller 16 may include hardware and/or software that is configured to implement the virtual machine torque capability calculator 314 in order to compute or otherwise determine the positive virtual machine positive current limit (I_{P+}) for operating the DW-PMDC machine 60 to generate torque in the first direction. The positive virtual machine positive current limit (I_{P+}) may be calculated as described in equation (5), above.

In some embodiments, the first method 400 may further include determining, based on the positive virtual machine positive current limit (I_{P+}), the positive torque capability (T_{cap+}) of the DW-PMDC machine. For example, the controller 16 may include hardware and/or software that is configured to implement the virtual machine torque capability calculator 314 in order to compute or otherwise determine the positive torque capability (T_{cap+}) of the DW-PMDC machine 60 based on the positive virtual machine positive current limit (I_{P+}). The positive torque capability (T_{cap+}) may be calculated as described in equation (7), above.

In some embodiments, the first method 400 may further include determining, based on the positive virtual machine upper voltage limit (Vₚᵤ), a positive virtual machine negative upper voltage limit (Vₚᵤ) for operating the DW-PMDC machine to generate a torque in the second direction. For example, the controller 16 may include hardware and/or software that is configured to implement the virtual machine limits calculator 312 in order to compute or otherwise determine the positive virtual machine negative upper voltage limit Vₚᵤ₋ based on the positive virtual machine upper voltage limit Vₚᵤ. The positive virtual machine negative upper voltage limit Vₚᵤ₋ may be determined as −Vₚᵤ.

In some embodiments, the first method 400 may further include determining, based on the positive virtual machine negative upper voltage limit (Vₚᵤ₋), a positive virtual machine negative current limit (I_{P-}) for operating the DW-PMDC machine to generate torque in the second direction. For example, the controller 16 may include hardware and/or software that is configured to implement the virtual machine torque capability calculator 314 in order to compute or otherwise determine the positive virtual machine negative current limit (I_{P-}) for operating the DW-PMDC machine 60 to generate torque in the second direction. The positive virtual machine negative current limit (I_{P-}) may be calculated as described in equation (6), above

In some embodiments, the first method 400 may further include determining, based on the positive virtual machine negative current limit (I_{P-}), the negative torque capability (T_{cap-}) of the DW-PMDC machine. For example, the controller 16 may include hardware and/or software that is configured to implement the virtual machine torque capability calculator 314 in order to compute or otherwise determine the negative torque capability (T_{cap-}) of the DW-PMDC machine 60 based on the positive virtual machine negative current limit (I_{P-}). The negative torque capability (T_{cap-}) may be calculated as described in equation (8), above.

The first method 400 also includes determining, at step 404 and based on the positive virtual machine current (Iₚ), a positive virtual machine voltage (Vₚ). For example, the controller 16 may include hardware and/or software that is configured to implement the positive virtual machine model 322 in order to compute or otherwise determine the positive virtual machine voltage Vₚ based on the positive virtual machine current Iₚ. Step 404 may include calculating the positive virtual machine voltage Vₚ as described in equation (11), above.

The first method 400 also includes determining, at step 406 and based on a first DC supply voltage (V_{dc1}) of a power supply to a first power converter and a second DC supply voltage (V_{dc2}) of a power supply to a second power converter, a positive virtual machine lower voltage limit (Vₚₗ). For example, the controller 16 may include hardware and/or software that is configured to implement the virtual machine limits calculator 312 in order to compute or otherwise determine the positive virtual machine lower voltage limit Vₚₗ based on the first DC supply voltage V_{dc1} and the second DC supply voltage V_{dc2}. Step 406 may include calculating the positive virtual machine lower voltage limit Vₚₗ as described in equation set (4), above.

The first method 400 also includes determining, at step 408 and based on the positive virtual machine voltage (Vₚ) and the positive virtual machine lower voltage limit (Vₚₗ), a negative virtual machine voltage (Vₙ). For example, the controller 16 may include hardware and/or software that is configured to implement the negative virtual machine model 324 in order to compute or otherwise determine the negative virtual machine voltage Vₙ based on the positive virtual machine voltage Vₚ and the positive virtual machine lower voltage limit Vₚₗ. Step 408 may include calculating the negative virtual machine voltage Vₙ as described in equation (12), above.

In some embodiments, the first method 400 may further include determining a negative virtual machine voltage limit (V_{n_lim}) based on a difference between the first DC supply voltage (V_{dc1}) and the second DC supply voltage (V_{dc2}). For example, the controller 16 may include hardware and/or software that is configured to implement the virtual machine limits calculator 312 in order to compute or otherwise determine the negative virtual machine voltage limit V_{n_lim} based on a difference between the first DC supply voltage V_{dc1} and the second DC supply voltage V_{dc2}. The negative virtual machine voltage limit (V_{n_lim}) may be calculated as described in equation set (4), above.

In some embodiments, step 408 may include calculating the negative virtual machine voltage (Vₙ) further based on a negative virtual machine voltage limit (V_{n_lim}). For example, step 408 may include determining the negative virtual machine voltage (Vₙ) further based on the polarity, or sign, of the negative virtual machine voltage limit (V_{n_lim}).

The first method 400 also includes determining, at step 410 and based on the negative virtual machine voltage (Vₙ), a negative virtual machine current (Iₙ). For example, the controller 16 may include hardware and/or software that is configured to implement the negative virtual machine model 324 in order to compute or otherwise determine the negative virtual machine current Iₙ based on the negative virtual machine voltage Vₙ. Step 410 may include calculating the negative virtual machine current Iₙ as described in equation (13), above.

The first method 400 also includes determining, at step 412 and by applying a mathematical transformation to a set of the positive virtual machine current (Iₚ) and the negative virtual machine current (Iₙ), a first final current command

$$( {I}_{1}^{*} )$$

and a second final current command

$$( {I}_{2}^{*} ) .$$

For example, the controller 16 may include hardware and/or software that is configured to implement the virtual inverse transformation 330 in order to compute or otherwise determine the first final current command

$${I}_{1}^{*}$$

and the second final current command

$${I}_{2}^{*} .$$

Step 412 may include calculating the first final current command

$$( {I}_{1}^{*} )$$

and the second final current command

$$( {I}_{2}^{*} )$$

as described in equations (14) and (15), above.

The first method 400 also includes commanding, at step 414 and based on the first final current command

$$( {I}_{1}^{*} ) ,$$

the first power converter to apply a first DC output voltage to the first winding set and thereby causing a first output current to be generated in the first winding set in accordance with the first final current command

$$( {I}_{1}^{*} ) .$$

For example, the controller 16 may include hardware and/or software that is configured to implement the first motor current controller 74a for commanding operation of the first power converter 66a to cause the first power converter 66a to apply the first output voltage V₁ to the first winding set 62a.

The first method 400 also includes commanding, at step 416 and based on the second final current command

$$( {I}_{2}^{*} ) ,$$

the second power converter to apply a second DC output voltage to the second winding set and thereby causing a second output current to be generated in the second winding set in accordance with the second final current command

$$( {I}_{2}^{*} ) .$$

for example, the controller 16 may include hardware and/or software that is configured to implement the second motor current controller 74b for commanding operation of the second power converter 66b to cause the second power converter 66b to apply the second output voltage V₂ to the second winding set 62b.

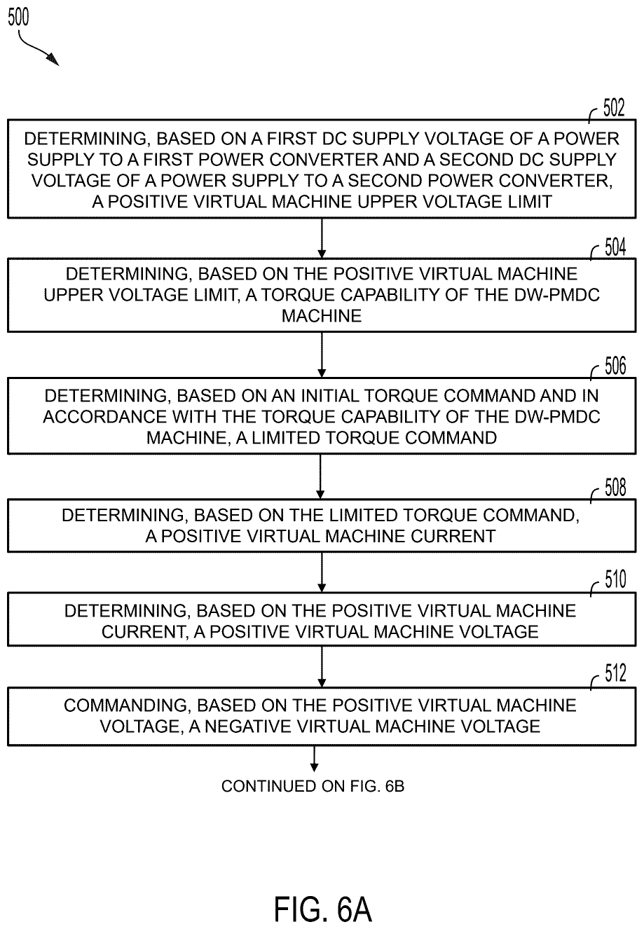

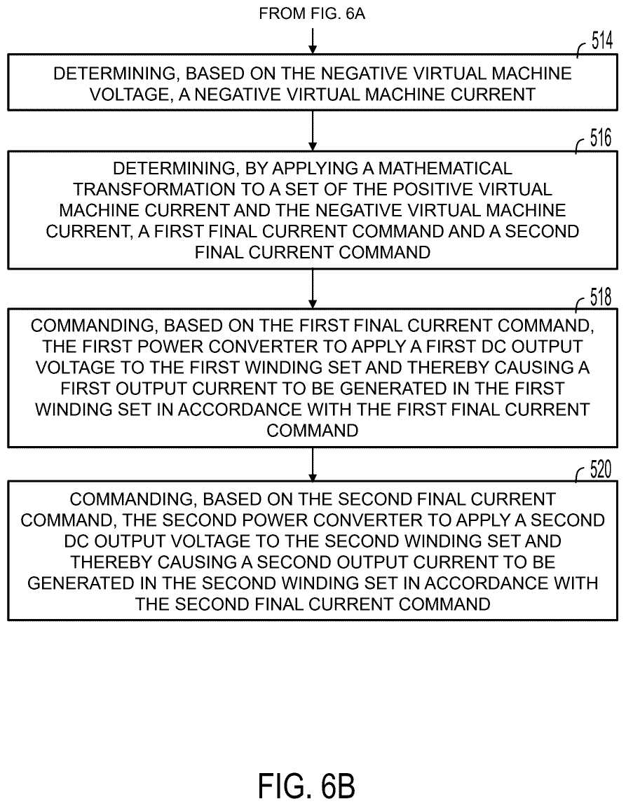

FIGS. 6A-6B show a flow diagram illustrating a second method 500 for controlling a dual winding permanent magnet direct current (DW-PMDC) machine, also called a DW-PMDC machine 60, having a first winding set 62a and a second winding set 62b according to the principles of the present disclosure. The second method 500 can be performed by the controller 16 or either or both of the ECUs 57, 58, in accordance with some embodiments of the present disclosure. As can be appreciated in light of the disclosure, the order of operation within the method is not limited to the sequential execution as illustrated in FIGS. 6A-6B, but may be performed in one or more varying orders as applicable and in accordance with the present disclosure.

The second method 500 includes determining, at step 502 and based on a first DC supply voltage (V_{dc1}) of a power supply to a first power converter and a second DC supply voltage (V_{dc2}) of a power supply to a second power converter, a positive virtual machine upper voltage limit (Vₚᵤ). For example, the controller 16 may include hardware and/or software that is configured to implement the virtual machine limits calculator 312 in order to compute or otherwise determine the positive virtual machine upper voltage limit Vₚᵤ based on the first DC supply voltage V_{dc1} and the second DC supply voltage V_{dc2}. The virtual machine upper voltage limit Vₚᵤ may be calculated as described in equation set (4), above.

The second method 500 also includes determining, at step 504 and based on the positive virtual machine upper voltage limit (Vₚᵤ), a torque capability (T_{cap+}, T_{cap-}) of the DW-PMDC machine. For example, the controller 16 may include hardware and/or software that is configured to implement the virtual machine torque capability calculator 314 in order to compute or otherwise determine the torque capability (T_{cap+}, T_{cap-}) of the DW-PMDC machine 60 based on positive virtual machine upper voltage limit (Vₚᵤ). The torque capability (T_{cap+}, T_{cap-}) of the DW-PMDC machine 60 may be calculated as described in equations (5)-(8), above.

The second method 500 also includes determining, at step 506 and based on an initial torque command

$$( {T}_{e}^{*} )$$

and in accordance with the torque capability (T_{cap+}, T_{cap-}) of the DW-PMDC machine, a limited torque command

$$( {T}_{lim}^{*} ) .$$

For example, the controller 16 may include hardware and/or software that is configured to implement the torque command limiter 302 to determine the limited torque command

$$( {T}_{lim}^{*} )$$

based on an initial torque command

$$( {T}_{e}^{*} )$$

and in accordance with a torque capability (T_{cap+}, T_{cap-}) of the DW-PMDC machine 60. Step 506 may include calculating the limited torque command

$$( {T}_{lim}^{*} )$$

as described in equation (9), above.

The second method 500 also includes determining, at step 508 and based on the limited torque command

$$( {T}_{lim}^{*} ) ,$$

a positive virtual machine current (Iₚ). For example, the controller 16 may include hardware and/or software that is configured to implement the positive virtual machine model 322 in order to compute or otherwise determine the positive virtual machine current Iₚ based on the limited torque command

$${T}_{lim}^{*} .$$

Step 508 may include calculating the positive virtual machine current Iₚ as described in equation (10), above.

The second method 500 also includes determining, at step 510 and based on the positive virtual machine current (Iₚ), a positive virtual machine voltage (Vₚ). For example, the controller 16 may include hardware and/or software that is configured to implement the positive virtual machine model 322 in order to compute or otherwise determine the positive virtual machine voltage Vₚ based on the positive virtual machine current Iₚ. Step 510 may include calculating the positive virtual machine voltage Vₚ as described in equation (11), above.

The second method 500 also includes determining, at step 512 and based on the positive virtual machine voltage (Vₚ), a negative virtual machine voltage (Vₙ). For example, the controller 16 may include hardware and/or software that is configured to implement the negative virtual machine model 324 in order to compute or otherwise determine the negative virtual machine voltage Vₙ based on the positive virtual machine voltage Vₚ. Step 512 may include calculating the negative virtual machine voltage Vₙ, as described in equation (12), above.

In some embodiments, the second method 500 may further include determining a positive virtual machine lower voltage limit (Vₚₗ) based on a first DC supply voltage (V_{dc1}) and a second DC supply voltage (V_{dc2}). For example, the controller 16 may include hardware and/or software that is configured to implement the virtual machine limits calculator 312 in order to compute or otherwise determine the positive virtual machine lower voltage limit Vₚₗ based on the first DC supply voltage V_{dc1} and the second DC supply voltage V_{dc2}. The positive virtual machine lower voltage limit Vₚₗ may be calculated as described in equation set (4), above. In some embodiments. step 512 further includes determining the negative virtual machine voltage (Vₙ) further based on the positive virtual machine lower voltage limit (Vₚₗ).

The second method 500 also includes determining, at step 514 and based on the negative virtual machine voltage (Vₙ), a negative virtual machine current (Iₙ). For example, the controller 16 may include hardware and/or software that is configured to implement the negative virtual machine model 324 in order to compute or otherwise determine the negative virtual machine current Iₙ based on the negative virtual machine voltage Vₙ. Step 514 may include calculating the negative virtual machine current Iₙ as described in equation (13), above.

The second method 500 also includes determining, at step 516 and by applying a mathematical transformation to a set of the positive virtual machine current (Iₚ) and the negative virtual machine current (Iₙ), a first final current command

$$( {I}_{1}^{*} )$$

and a second final current command

$$( {I}_{2}^{*} ) .$$

For example, the controller 16 may include hardware and/or software that is configured to implement the virtual inverse transformation 330 in order to compute or otherwise determine the first final current command

$${I}_{1}^{*}$$

and the second final current command

$${I}_{2}^{*} .$$

Step 516 may include calculating the first final current command

$$( {I}_{1}^{*} )$$

and the second final current command

$$( {I}_{2}^{*} )$$

as described in equations (14) and (15), above.

The second method 500 also includes commanding, at step 518 and based on the first final current command

$$( {I}_{1}^{*} ) ,$$

the first power converter to apply a first DC output voltage to the first winding set and thereby causing a first output current to be generated in the first winding set in accordance with the first final current command

$$( {I}_{1}^{*} ) .$$

For example, the controller 16 may include hardware and/or software that is configured to implement the first motor current controller 74a for commanding operation of the first power converter 66a to cause the first power converter 66a to apply the first output voltage V₁ to the first winding set 62a.

The second method 500 also includes commanding, at step 520 and based on the second final current command

$$( {I}_{2}^{*} ) ,$$

the second power converter to apply a second DC output voltage to the second winding set and thereby causing a second output current to be generated in the second winding set in accordance with the second final current command

$$( {I}_{2}^{*} ) .$$

For example, the controller 16 may include hardware and/or software that is configured to implement the second motor current controller 74b for commanding operation of the second power converter 66b to cause the second power converter 66b to apply the second output voltage V₂ to the second winding set 62b.

The present disclosure provides a method of controlling a dual winding permanent magnet direct current (DW-PMDC) machine having a first winding set and a second winding set. The method comprises: determining, based on an initial torque command

$$( {T}_{e}^{*} ) ,$$

a positive virtual machine current (Iₚ); determining, based on the positive virtual machine current (Iₚ), a positive virtual machine voltage (Vₚ); determining, based on a first DC supply voltage (V_{dc1}) of a power supply to a first power converter and a second DC supply voltage (V_{dc2}) of a power supply to a second power converter, a positive virtual machine lower voltage limit (Vₚₗ); determining, based on the positive virtual machine voltage (Vₚ) and the positive virtual machine lower voltage limit (Vₚₗ), a negative virtual machine voltage (Vₙ); determining, based on the negative virtual machine voltage (Vₙ), a negative virtual machine current (Iₙ); determining, by applying a mathematical transformation to a set of the positive virtual machine current (Iₚ) and the negative virtual machine current (Iₚ), a first final current command

$$( {I}_{1}^{*} )$$

an a second final current command

$$( {I}_{2}^{*} ) ;$$

commanding, based on the first final current command

$$( {I}_{1}^{*} ) ,$$

the first power converter to apply a first DC output voltage to the first winding set and thereby causing a first output current to be generated in the first winding set in accordance with the first final current command

$$( {I}_{1}^{*} ) ;$$

and commanding, based on the second final current command

$$( {I}_{2}^{*} ) ,$$

the second power converter to apply a second DC output voltage to the second winding set and thereby causing a second output current to be generated in the second winding set in accordance with the second final current command

$$( {I}_{2}^{*} ) .$$

In some embodiments, determining the first final current command

$$( {I}_{1}^{*} )$$

and the second final current command

$$( {I}_{2}^{*} )$$

further includes computing the first final current command

$$( {I}_{1}^{*} )$$

and the second final current command

$$( {I}_{2}^{*} )$$

in accordance with:

$${I}_{1}^{*} = \frac{{I}_{p} + {I}_{n}}{2} , {I}_{2}^{*} = \frac{{I}_{p} - {I}_{n}}{2} .$$

In some embodiments, the method further comprises: determining, based on the first DC supply voltage and the second DC supply voltage, a positive virtual machine upper voltage limit (Vₚᵤ); determining, based on the positive virtual machine upper voltage limit (Vₚᵤ), a torque capability (T_{cap+}, T_{cap-}) of the DW-PMDC machine; and determining based on the initial torque command

$$( {T}_{e}^{*} )$$

and in accordance with the torque capability (T_{cap+}, T_{cap-}) of the DW-PMDC machine, a limited torque command

$$( {T}_{lim}^{*} ) .$$

In some embodiments, determining the positive virtual machine current (Iₚ) based on the initial torque command

$$( {T}_{e}^{*} )$$

includes determining the positive virtual machine current (Iₚ) further based on the limited torque command

$$( {T}_{lim}^{*} ) .$$

In some embodiments, determining the positive virtual machine current (Iₚ) further based on the limited torque command

$$( {T}_{lim}^{*} )$$

further includes computing the positive virtual machine current (Iₚ) in accordance with:

$${I}_{p} = \frac{{T}_{lim}^{*}}{{K}_{e}} ,$$

where Kₑ is a back-emf constant of the DW-PMDC machine.

In some embodiments, the torque capability (T_{cap+}, T_{cap-}) of the DW-PMDC machine includes: a positive torque capability (T_{cap+}) of the DW-PMDC machine to generate torque in a first direction, and a negative torque capability (T_{cap-}) of the DW-PMDC machine to generate torque in a second direction opposite the first direction. In some embodiments, the method further includes: determining, based on the positive virtual machine upper voltage limit (Vₚᵤ), a positive virtual machine positive upper voltage limit (Vₚᵤ₊) for operating the DW-PMDC machine to generate a torque in the first direction; determining, based on the positive virtual machine positive upper voltage limit (Vₚᵤ₊), a positive virtual machine positive current limit (I_{P+}) for operating the DW-PMDC machine to generate torque in the first direction; determining, based on the positive virtual machine positive current limit (I_{P+}), the positive torque capability (T_{cap+}) of the DW-PMDC machine; determining, based on the positive virtual machine upper voltage limit (Vₚᵤ), a positive virtual machine negative upper voltage limit (Vₚᵤ₋) for operating the DW-PMDC machine to generate a torque in the second direction; determining, based on the positive virtual machine negative upper voltage limit (Vₚᵤ₋), a positive virtual machine negative current limit (I_{P-}) for operating the DW-PMDC machine to generate torque in the second direction; and determining, based on the positive virtual machine negative current limit (I_{P-}), the negative torque capability (T_{cap-}) of the DW-PMDC machine.

In some embodiments, determining the positive virtual machine positive current limit (I_{P+}) further includes calculating the positive virtual machine positive current limit (I_{P+}) in accordance with:

$${I}_{p +} = \frac{{V}_{pu +} - 2 {K}_{e} {ω}_{m} - {V}_{bdp}}{R} ,$$

where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine.

In some embodiments, determining the positive torque capability (T_{cap+}) of the DW-PMDC machine further includes calculating the positive torque capability (T_{cap+}) in accordance with: T_{cap+}=KₑIₚ₊, where Kₑ is a back-emf constant of the DW-PMDC machine.

In some embodiments, determining the positive virtual machine negative current limit (I_{P-}) further includes calculating the positive virtual machine negative current limit (I_{P-}) in accordance with:

$${I}_{p -} = \frac{{V}_{pu -} - 2 {K}_{e} {ω}_{m} - {V}_{bdp}}{R} ,$$

where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine.

In some embodiments, determining the negative torque capability (T_{cap-}) of the DW-PMDC machine further includes calculating the negative torque capability (T_{cap-}) in accordance with: T_{cap-}=Kₑlₚ₋, where Kₑ is a back-emf constant of the DW-PMDC machine.

In some embodiments, the method further includes determining, based on a difference between the first DC supply voltage (V_{dc1}) and the second DC supply voltage (V_{dc2}), a negative virtual machine voltage limit (V_{n_lim}). In some embodiments, determining the negative virtual machine voltage (Vₙ) based on the positive virtual machine voltage (Vₚ) further includes calculating the negative virtual machine voltage (Vₙ) in accordance with:

$${V}_{n} = \{ \begin{matrix}0 , & if {V}_{pl -} \leq {V}_{p} \leq {V}_{p l +} \\ ( {V}_{p} - {V}_{pl +} ) * sign ( {V}_{n \_ lim} ) , & if {V}_{p} \geq {V}_{pl +} \\ ( {V}_{p} - {V}_{pl -} ) * sign ( {V}_{n \_ lim} ) , & if {V}_{p} \leq {V}_{pl -}\end{matrix} ,$$

where sign(V_{n_lim}) represents a function that returns +/−1, depending on a polarity of the negative virtual machine voltage limit (V_{n_lim}).

The present disclosure also provides another method of controlling a dual winding permanent magnet direct current (DW-PMDC) machine having a first winding set and a second winding set. The method comprises: determining, based on a first DC supply voltage (V_{dc1}) of a power supply to a first power converter and a second DC supply voltage (V_{dc2}) of a power supply to a second power converter, a positive virtual machine upper voltage limit (Vₚᵤ); determining, based on the positive virtual machine upper voltage limit (Vₚᵤ), a torque capability (T_{cap+}, T_{cap-}) of the DW-PMDC machine; determining based on an initial torque command

$$( {T}_{e}^{*} )$$

and in accordance with the torque capability (T_{cap+}, T_{cap-}) of the DW-PMDC machine, a limited torque command

$$( {T}_{lim}^{*} ) ;$$

determining, based on the limited torque command

$$( {T}_{lim}^{*} ) ,$$

a positive virtual machine current (Iₚ); determining, based on the positive virtual machine current (Iₚ), a positive virtual machine voltage (Vₚ); determining, based on the positive virtual machine voltage (Vₚ), a negative virtual machine voltage (Vₙ); determining, based on the negative virtual machine voltage (Vₙ), a negative virtual machine current (Iₙ); determining, by applying a mathematical transformation to a set of the positive virtual machine current (Iₚ) and the negative virtual machine current (Iₙ), a first final current command

$$( {I}_{1}^{*} )$$

and a second final current command

$$( {I}_{2}^{*} ) ;$$

commanding, based on the first final current command

$$( {I}_{1}^{*} ) ,$$

the first power converter to apply a first DC output voltage to the first winding set and thereby causing a first output current to be generated in the first winding set in accordance with the first final current command

$$( {I}_{1}^{*} ) ;$$

and commanding, based on the second final current command

$$( {I}_{2}^{*} ) ,$$

the second power converter to apply a second DC output voltage to the second winding set and thereby causing a second output current to be generated in the second winding set in accordance with the second final current command

$$( {I}_{2}^{*} ) .$$

In some embodiments, the method further includes: determining a positive virtual machine lower voltage limit (Vₚₗ) based on a first DC supply voltage (V_{dc1}) and a second DC supply voltage (V_{dc2}). In some embodiments, determining the negative virtual machine voltage (Vₙ) based on the positive virtual machine voltage (Vₚ) includes determining the negative virtual machine voltage (Vₙ) further based on the positive virtual machine lower voltage limit (Vₚₗ).

The present disclosure also provides a system for controlling a dual winding permanent magnet direct current (DW-PMDC) machine having a first winding set and a second winding set. The system comprises: a first power converter configured to selectively conduct current from a first DC voltage source having a first DC supply voltage, and to thereby apply a first DC output voltage to the first winding set of the DW-PMDC machine; a second power converter configured to selectively conduct current from a second DC voltage source having a second DC supply voltage, and to thereby apply a second DC output voltage to the second winding set of the DW-PMDC machine; and a controller. The controller is configured to: determine, based on an initial torque command

$$( {T}_{e}^{*} ) ,$$

a positive virtual machine current (Iₚ); determine a positive virtual machine voltage (Vₚ) based on the positive virtual machine current (Iₚ); determine, based on a first DC supply voltage (V_{dc1}) and a second DC supply voltage (V_{dc2}), a positive virtual machine lower voltage limit (Vₚₗ); determine, based on the positive virtual machine voltage (Vₚ) and the positive virtual machine lower voltage limit (Vₚₗ), a negative virtual machine voltage (Vₙ); determine, based on the negative virtual machine voltage (Vₙ), a negative virtual machine current (Iₙ); determine, by applying a mathematical transformation to a set of the positive virtual machine current (Iₚ) and the negative virtual machine current (Iₙ), a first final current command

$$( {I}_{1}^{*} )$$

and a second final current command

$$( {I}_{2}^{*} ) ;$$

command, based on the first final current command

$$( {I}_{1}^{*} ) ,$$

the first power converter to apply the first DC output voltage to the first winding set and thereby causing a first output current to be generated in the first winding set in accordance with the first final current command

$$( {I}_{1}^{*} ) ;$$

(and command, based on the second final current command

$$( {I}_{2}^{*} ) ,$$

the second power converter to apply the second DC output voltage to the second winding set and thereby causing a second output current to be generated in the second winding set in accordance with the second final current command.

$$( {I}_{2}^{*} ) .$$

In some embodiments, determining the first final current command

$$( {I}_{1}^{*} )$$

and the second final current command

$$( {I}_{2}^{*} )$$

by applying the mathematical transformation to the set of the positive virtual machine current (Iₚ) and the negative virtual machine current (Iₙ) further includes computing the first final current command

$$( {I}_{1}^{*} )$$

and the second final current command

$$( {I}_{2}^{*} )$$

in accordance with

$${I}_{1}^{*} = \frac{{I}_{p} + {I}_{n}}{2} ,$$

$${I}_{2}^{*} = \frac{{I}_{p} - {I}_{n}}{2} .$$

In some embodiments, the controller is further configured to: determine a positive virtual machine upper voltage limit (Vₚᵤ) based on the first DC supply voltage and the second DC supply voltage; determine, based on the positive virtual machine upper voltage limit (Vₚᵤ), a torque capability (T_{cap+}, T_{cap-}) of the DW-PMDC machine; and determine a limited torque command

$$( {T}_{lim}^{*} )$$

based on the initial torque command

$$( {T}_{e}^{*} )$$

and in accordance with the torque capability (T_{cap+}, T_{cap-}) of the DW-PMDC machine. In some embodiments, determining the positive virtual machine current (Iₚ) based on the initial torque command

$$( {T}_{e}^{*} )$$

includes determining the positive virtual machine current (Iₚ) further based on the limited torque command

$$( {T}_{lim}^{*} ) .$$

In some embodiments, determining the positive virtual machine current (Iₚ) further based on the limited torque command

$$( {T}_{lim}^{*} )$$

further includes computing the positive virtual machine current (Iₚ) in accordance with:

$${I}_{p} = \frac{{T}_{lim}^{*}}{{K}_{e}} ,$$

where Kₑ is a back-emf constant of the DW-PMDC machine.

In some embodiments, the torque capability (T_{cap+}, T_{cap-}) of the DW-PMDC machine includes: a positive torque capability (T_{cap+}) of the DW-PMDC machine to generate torque in a first direction, and a negative torque capability (T_{cap-}) of the DW-PMDC machine to generate torque in a second direction opposite the first direction. In some embodiments, the controller is further configured to: determine, based on the positive virtual machine upper voltage limit (Vₚᵤ), a positive virtual machine positive upper voltage limit (Vₚᵤ₊) for operating the DW-PMDC machine to generate a torque in the first direction; determine, based on the positive virtual machine positive upper voltage limit (Vₚᵤ₊), a positive virtual machine positive current limit (I_{P+}) for operating the DW-PMDC machine to generate torque in the first direction; determine, based on the positive virtual machine positive current limit (I_{P+}), the positive torque capability (T_{cap+}) of the DW-PMDC machine; determine, based on the positive virtual machine upper voltage limit (Vₚᵤ), a positive virtual machine negative upper voltage limit (Vₚᵤ₋) for operating the DW-PMDC machine to generate a torque in the second direction; determine, based on the positive virtual machine negative upper voltage limit (Vₚᵤ₋), a positive virtual machine negative current limit (I_{P-}) for operating the DW-PMDC machine to generate torque in the second direction; and determine, based on the positive virtual machine negative current limit (I_{P-}), the negative torque capability (T_{cap-}) of the DW-PMDC machine.

In some embodiments, determining the positive virtual machine positive current limit (I_{P+}) further includes calculating the positive virtual machine positive current limit (I_{P+}) in accordance with:

$${I}_{p +} = \frac{{V}_{pu +} - 2 {K}_{e} {ω}_{m} - {V}_{bdp}}{R} ,$$

where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine. In some embodiments, determining the positive torque capability (T_{cap+}) of the DW-PMDC machine further includes calculating the positive torque capability (T_{cap+}) in accordance with: T_{cap+}=Kₑ Iₚ₊, where Kₑ is a back-emf constant of the DW-PMDC machine.

In some embodiments, determining the positive virtual machine negative current limit (I_{P-}) further includes calculating the positive virtual machine negative current limit (I_{P-}) in accordance with:

$${I}_{p -} = \frac{{V}_{pu -} - 2 {K}_{e} {ω}_{m} - {V}_{bdp}}{R} ,$$

where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine. In some embodiments, determining the negative torque capability (T_{cap-}) of the DW-PMDC machine further includes calculating the negative torque capability (T_{cap-}) in accordance with: T_{cap-}=KₑIₚ₋, where Kₑ is a back-emf constant of the DW-PMDC machine.

In some embodiments, the controller is further configured to determine a negative virtual machine voltage limit (V_{n_lim}) based on a difference between the first DC supply voltage (V_{dc1}) and the second DC supply voltage (V_{dc2}). In some embodiments, determining the negative virtual machine voltage (Vₙ) based on the positive virtual machine voltage (Vₚ) further includes calculating the negative virtual machine voltage (Vₙ) in accordance with:

$${V}_{n} = \{ \begin{matrix}0 , & if {V}_{pl -} \leq {V}_{p} \leq {V}_{pl +} \\ ( {V}_{p} - {V}_{pl +} ) * sign ( {V}_{n \_ lim} ) , & if {V}_{p} \geq {V}_{pl +} \\ ( {V}_{p} - {V}_{pl -} ) * sign ( {V}_{n \_ lim} ) , & if {V}_{p} \leq {V}_{pl -}\end{matrix} ,$$

where sign(V_{n_lim}) represents a function that returns +/−1, depending on a polarity of the negative virtual machine voltage limit (V_{n_lim}).

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable storage media 13. A computer-usable or computer-readable storage media 13 can include any device that can, for example, tangibly contain, store, communicate, or transport the program for use by or in connection with any processor. The medium can be, for example, an electronic, magnetic, optical, electromagnetic, or a semiconductor device. Other suitable mediums are also available. When computer program code stored on the computer-readable storage media 13 is loaded into and executed by a computer or controller, the computer becomes an apparatus for practicing the invention. At least a portion of the implementations of the present disclosure may also be embodied in the form of computer program code as a data signal 15, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be appreciated that the use of first and second or other similar nomenclature for denoting similar items is not intended to specify or imply any particular order unless otherwise stated.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A method of controlling a dual winding permanent magnet direct current (DW-PMDC) machine having a first winding set and a second winding set, the method comprising:
determining, based on an initial torque command
$$( {T}_{e}^{*} ) ,$$
a positive virtual machine current (Iₚ);
determining, based on the positive virtual machine current (Iₚ), a positive virtual machine voltage (Vₚ);
determining, based on a first DC supply voltage (V_{dc1}) of a power supply to a first power converter and a second DC supply voltage (V_{dc2}) of a power supply to a second power converter, a positive virtual machine lower voltage limit (Vₚₗ);
determining, based on the positive virtual machine voltage (Vₚ) and the positive virtual machine lower voltage limit (Vₚₗ), a negative virtual machine voltage (Vₙ);
determining, based on the negative virtual machine voltage (Vₙ), a negative virtual machine current (Iₙ);
determining, by applying a mathematical transformation to a set of the positive virtual machine current (Iₚ) and the negative virtual machine current (Iₙ), a first final current command
$$( {I}_{1}^{*} )$$
and a second final current command
$$( {I}_{2}^{*} ) ;$$
commanding, based on the first final current command
$$( {I}_{1}^{*} ) ,$$
the first power converter to apply a first DC output voltage to the first winding set and thereby causing a first output current to be generated in the first winding set in accordance with the first final current command
$$( {I}_{1}^{*} )$$
and
commanding, based on the second final current command
$$( {I}_{2}^{*} ) ,$$
the second power converter to apply a second DC output voltage to the second winding set and thereby causing a second output current to be generated in the second winding set in accordance with the second final current command
$$( {I}_{2}^{*} ) .$$

2. The method of claim 1, wherein determining the first final current command
$$( {I}_{1}^{*} )$$
and the second final current command
$$( {I}_{2}^{*} )$$
further includes computing the first final current command
$$( {I}_{1}^{*} )$$
and the second final current command
$$( {I}_{2}^{*} )$$
in accordance with:
$${I}_{1}^{*} = \frac{{I}_{p} + {I}_{n}}{2} ,$$
$${I}_{2}^{*} = \frac{{I}_{p} - {I}_{n}}{2} .$$

3. The method of claim 1, further comprising:
determining, based on the first DC supply voltage and the second DC supply voltage, a positive virtual machine upper voltage limit (Vₚᵤ);
determining, based on the positive virtual machine upper voltage limit (Vₚᵤ), a torque capability (T_{cap+}, T_{cap-}) of the DW-PMDC machine; and
determining based on the initial torque command
$$( {T}_{e}^{*} )$$
and in accordance with the torque capability (T_{cap+}, T_{cap-}) of the DW-PMDC machine, a limited torque command
$$( {T}_{lim}^{*} ) ,$$
wherein determining the positive virtual machine current (Iₚ) based on the initial torque command
$$( {T}_{e}^{*} )$$
includes determining the positive virtual machine current (Iₚ) further based on the limited torque command
$$( {T}_{lim}^{*} ) .$$

4. The method of claim 3, wherein determining the positive virtual machine current (Iₚ) further based on the limited torque command
$$( {T}_{lim}^{*} )$$
further includes computing the positive virtual machine current (Iₚ) in accordance with:
$${I}_{p} = \frac{{T}_{lim}^{*}}{{K}_{e}} ,$$
where Kₑ is a back-emf constant of the DW-PMDC machine.

5. The method of claim 3, wherein the torque capability (T_{cap+}, T_{cap-}) of the DW-PMDC machine includes: a positive torque capability (T_{cap+}) of the DW-PMDC machine to generate torque in a first direction, and a negative torque capability (T_{cap-}) of the DW-PMDC machine to generate torque in a second direction opposite the first direction, and
wherein the method further includes:
determining, based on the positive virtual machine upper voltage limit (Vₚᵤ), a positive virtual machine positive upper voltage limit (Vₚᵤ₊) for operating the DW-PMDC machine to generate a torque in the first direction;
determining, based on the positive virtual machine positive upper voltage limit (Vₚᵤ₊), a positive virtual machine positive current limit (I_{P+}) for operating the DW-PMDC machine to generate torque in the first direction;
determining, based on the positive virtual machine positive current limit (I_{P+}), the positive torque capability (T_{cap+}) of the DW-PMDC machine;
determining, based on the positive virtual machine upper voltage limit (Vₚᵤ), a positive virtual machine negative upper voltage limit (Vₚᵤ₋) for operating the DW-PMDC machine to generate a torque in the second direction;
determining, based on the positive virtual machine negative upper voltage limit (Vₚᵤ₋), a positive virtual machine negative current limit (I_{P-}) for operating the DW-PMDC machine to generate torque in the second direction; and
determining, based on the positive virtual machine negative current limit (I_{P-}), the negative torque capability (T_{cap-}) of the DW-PMDC machine.

6. The method of claim 5, wherein determining the positive virtual machine positive current limit (I_{P+}) further includes calculating the positive virtual machine positive current limit (I_{P+}) in accordance with:
$${I}_{p +} = \frac{{V}_{pu +} - 2 {K}_{e} {ω}_{m} - {V}_{bdp}}{R} ,$$
where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine.

7. The method of claim 5, wherein determining the positive torque capability (T_{cap+}) of the DW-PMDC machine further includes calculating the positive torque capability (T_{cap+}) in accordance with: T_{cap+}=KₑIₚ+, where Kₑ is a back-emf constant of the DW-PMDC machine.

8. The method of claim 5, wherein determining the positive virtual machine negative current limit (I_{P-}) further includes calculating the positive virtual machine negative current limit (I_{P-}) in accordance with:
$${I}_{p -} = \frac{{V}_{pu -} - 2 {K}_{e} {ω}_{m} - {V}_{bdp}}{R} ,$$
where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine.

9. The method of claim 5, wherein determining the negative torque capability (T_{cap-}) of the DW-PMDC machine further includes calculating the negative torque capability (T_{cap-}) in accordance with: T_{cap-}=KₑIₚ₋, where Kₑ is a back-emf constant of the DW-PMDC machine.

10. The method of claim 1, further including determining, based on a difference between the first DC supply voltage (V_{dc1}) and the second DC supply voltage (V_{dc2}), a negative virtual machine voltage limit (V_{n_lim}), and
wherein determining the negative virtual machine voltage (V) based on the positive virtual machine voltage (Vₚ) further includes calculating the negative virtual machine voltage (Vₙ) in accordance with:
$${V}_{n} = \{ \begin{matrix}0 , & if {V}_{pl -} \leq {V}_{p} \leq {V}_{pl +} \\ ( {V}_{p} - {V}_{pl +} ) * sign ( {V}_{n \_ lim} ) , & if {V}_{p} \geq {V}_{pl +} \\ ( {V}_{p} - {V}_{pl -} ) * sign ( {V}_{n \_ lim} ) , & if {V}_{p} \leq {V}_{pl -}\end{matrix} ,$$
where sign(V_{n_lim}) represents a function that returns +/−1, depending on a polarity of the negative virtual machine voltage limit (V_{n_lim}).

11. A method of controlling a dual winding permanent magnet direct current (DW-PMDC) machine having a first winding set and a second winding set, the method comprising:
determining, based on a first DC supply voltage (V_{dc1}) of a power supply to a first power converter and a second DC supply voltage (V_{dc2}) of a power supply to a second power converter, a positive virtual machine upper voltage limit (Vₚᵤ);
determining, based on the positive virtual machine upper voltage limit (Vₚᵤ), a torque capability (T_{cap+}, T_{cap-}) of the DW-PMDC machine;
determining based on an initial torque command
$$( {T}_{e}^{*} )$$
and in accordance with the torque capability (T_{cap+}, T_{cap-}) of the DW-PMDC machine, a limited torque command
$$( {T}_{lim}^{*} ) ;$$
determining, based on the limited torque command
$$( {T}_{lim}^{*} ) ,$$
a positive virtual machine current (Iₚ);
determining, based on the positive virtual machine current (Iₚ), a positive virtual machine voltage (Vₚ);
determining, based on the positive virtual machine voltage (Vₚ), a negative virtual machine voltage (Vₙ);
determining, based on the negative virtual machine voltage (Vₙ), a negative virtual machine current (Iₙ);
determining, by applying a mathematical transformation to a set of the positive virtual machine current (Iₚ) and the negative virtual machine current (Iₙ), a first final current command
$$( {I}_{1}^{*} )$$
and a second final current command (I₂*);
commanding, based on the first final current command
$$( {I}_{1}^{*} ) ,$$
the first power converter to apply a first DC output voltage to the first winding set and thereby causing a first output current to be generated in the first winding set in accordance with the first final current command
$$( {I}_{1}^{*} ) ;$$
and
commanding, based on the second final current command
$$( {I}_{2}^{*} ) ,$$
the second power converter to apply a second DC output voltage to the second winding set and thereby causing a second output current to be generated in the second winding set in accordance with the second final current command
$$( {I}_{2}^{*} ) .$$

12. The method of claim 11, further including: determining a positive virtual machine lower voltage limit (Vₚₗ) based on a first DC supply voltage (V_{dc1}) and a second DC supply voltage (V_{dc2}), and
wherein determining the negative virtual machine voltage (Vₙ) based on the positive virtual machine voltage (Vₚ) includes determining the negative virtual machine voltage (Vₙ) further based on the positive virtual machine lower voltage limit (Vₚₗ).

13. A system for controlling a dual winding permanent magnet direct current (DW-PMDC) machine having a first winding set and a second winding set, the system comprising:
a first power converter configured to selectively conduct current from a first DC voltage source having a first DC supply voltage, and to thereby apply a first DC output voltage to the first winding set of the DW-PMDC machine;
a second power converter configured to selectively conduct current from a second DC voltage source having a second DC supply voltage, and to thereby apply a second DC output voltage to the second winding set of the DW-PMDC machine; and
a controller configured to:
determine, based on an initial torque command
$$( {T}_{e}^{*} ) ,$$
a positive virtual machine current (Iₚ);
determine a positive virtual machine voltage (Vₚ) based on the positive virtual machine current (Iₚ);
determine, based on a first DC supply voltage (V_{dc1}) and a second DC supply voltage (V_{dc2}), a positive virtual machine lower voltage limit (Vₚₗ);
determine, based on the positive virtual machine voltage (Vₚ) and the positive virtual machine lower voltage limit (Vₚₗ), a negative virtual machine voltage (Vₙ);
determine, based on the negative virtual machine voltage (Vₙ), a negative virtual machine current (Iₙ);
determine, by applying a mathematical transformation to a set of the positive virtual machine current (Iₚ) and the negative virtual machine current (Iₙ), a first final current command
$$( {I}_{1}^{*} )$$
and a second final current command
$$( {I}_{2}^{*} ) ;$$
command, based on the first final current command
$$( {I}_{1}^{*} ) ,$$
the first power converter to apply the first DC output voltage to the first winding set and thereby causing a first output current to be generated in the winding set in accordance with the first final current command
$$( {I}_{1}^{*} ) ;$$
and
command, based on the second final current command
$$( {I}_{2}^{*} ) ,$$
the second power converter to apply the second DC output voltage to the second winding set and thereby causing a second output current to be generated in the second winding set in accordance with the second final current command
$$( {I}_{2}^{*} ) .$$

14. The system of claim 13, wherein determining the first final current command
$$( {I}_{1}^{*} )$$
and the second final current command
$$( {I}_{2}^{*} )$$
further includes computing the first final current command (I₁*) and the second final current command
$$( {I}_{2}^{*} )$$
in accordance with:
$${I}_{1}^{*} = \frac{{I}_{p} + {I}_{n}}{2} , {I}_{2}^{*} = \frac{{I}_{p} - {I}_{n}}{2} .$$

15. The system of claim 13, wherein the controller is further configured to:
determine a positive virtual machine upper voltage limit (Vₚᵤ) based on the first DC supply voltage and the second DC supply voltage;
determine, based on the positive virtual machine upper voltage limit (Vₚᵤ), a torque capability (T_{cap+}, T_{cap-}) of the DW-PMDC machine; and
determine a limited torque command
$$( {T}_{lim}^{*} )$$
based on the initial torque command
$$( {T}_{e}^{*} )$$
and in accordance with the torque capability (T_{cap+}, T_{cap-}) of the DW-PMDC machine,
wherein determining the positive virtual machine current (Iₚ) based on the initial torque command
$$( {T}_{e}^{*} )$$
includes determining the positive virtual machine current (Iₚ) further based on the limited torque command
$$( {T}_{lim}^{*} ) .$$

16. The system of claim 15, wherein determining the positive virtual machine current (Iₚ) further based on the limited torque command
$$( {T}_{lim}^{*} )$$
further includes computing the positive virtual machine current (Iₚ) in accordance with:
$${I}_{p} = \frac{{T}_{lim}^{*}}{{K}_{e}} ,$$
where Kₑ is a back-emf constant of the DW-PMDC machine.

17. The system of claim 15, wherein the torque capability (T_{cap+}, T_{cap-}) of the DW-PMDC machine includes: a positive torque capability (T_{cap+}) of the DW-PMDC machine to generate torque in a first direction, and a negative torque capability (T_{cap-}) of the DW-PMDC machine to generate torque in a second direction opposite the first direction, and
wherein the controller is further configured to:
determine, based on the positive virtual machine upper voltage limit (Vₚᵤ), a positive virtual machine positive upper voltage limit (Vₚᵤ₊) for operating the DW-PMDC machine to generate a torque in the first direction;
determine, based on the positive virtual machine positive upper voltage limit (Vₚᵤ₊), a positive virtual machine positive current limit (I_{P+}) for operating the DW-PMDC machine to generate torque in the first direction;
determine, based on the positive virtual machine positive current limit (I_{P+}), the positive torque capability (T_{cap+}) of the DW-PMDC machine;
determine, based on the positive virtual machine upper voltage limit (Vₚᵤ), a positive virtual machine negative upper voltage limit (Vₚᵤ₋) for operating the DW-PMDC machine to generate a torque in the second direction;
determine, based on the positive virtual machine negative upper voltage limit (Vₚᵤ₋), a positive virtual machine negative current limit (I_{P-}) for operating the DW-PMDC machine to generate torque in the second direction; and
determine, based on the positive virtual machine negative current limit (I_{P-}), the negative torque capability (T_{cap-}) of the DW-PMDC machine.

18. The system of claim 17, wherein determining the positive virtual machine positive current limit (I_{P+}) further includes calculating the positive virtual machine positive current limit (I_{P+}) in accordance with:
$${I}_{p +} = \frac{{V}_{pu +} - 2 {K}_{e} {ω}_{m} - {V}_{bdp}}{R} ,$$
where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine, and
wherein determining the positive torque capability (T_{cap+}) of the DW-PMDC machine further includes calculating the positive torque capability (T_{cap+}) in accordance with: T_{cap+}=KₑIₚ+, where Kₑ is a back-emf constant of the DW-PMDC machine.

19. The system of claim 17, wherein determining the positive virtual machine negative current limit (I_{P-}) further includes calculating the positive virtual machine negative current limit (I_{P-}) in accordance with:
$${I}_{p -} = \frac{{V}_{pu -} - 2 {K}_{e} {ω}_{m} - {V}_{bdp}}{R} ,$$
where Kₑ is a back-emf constant of the DW-PMDC machine, ωₘ is a mechanical speed of the DW-PMDC machine, V_{bdp} is a positive virtual machine brush voltage drop, and R is a winding resistance of the DW-PMDC machine, and
wherein determining the negative torque capability (T_{cap-}) of the DW-PMDC machine further includes calculating the negative torque capability (T_{cap-}) in accordance with: T_{cap-}=KₑIₚ₋, where Kₑ is a back-emf constant of the DW-PMDC machine.

20. The system of claim 13, wherein the controller is further configured to determine a negative virtual machine voltage limit (V_{n_lim}) based on a difference between the first DC supply voltage (V_{dc1}) and the second DC supply voltage (V_{dc2}), and
wherein determining the negative virtual machine voltage (Vₙ) based on the positive virtual machine voltage (Vₚ) further includes calculating the negative virtual machine voltage (Vₙ) in accordance with:
$${V}_{n} = \{ \begin{matrix}0 , & if {V}_{pl -} \leq {V}_{p} \leq {V}_{pl +} \\ ( {V}_{p} - {V}_{pl +} ) * sign ( {V}_{n \_ lim} ) , & if {V}_{p} \geq {V}_{pl +} \\ ( {V}_{p} - {V}_{pl -} ) * sign ( {V}_{n \_ lim} ) , & if {V}_{p} \leq {V}_{pl -}\end{matrix} ,$$
where sign(V_{n_lim}) represents a function that returns +/−1, depending on a polarity of the negative virtual machine voltage limit (V_{n_lim}).
